(19) United States
(12) Patent Application Publication
(10) Pub. No.: US 2014/0176370 A1
(43) Pub. Date: Jun. 26, 2014

(54) ANTENNA, ELECTRONIC APPARATUS WITH THE SAME, AND ANTENNA MANUFACTURING METHOD

(71) Applicant: Samsung Electrics Co., Ltd, Suwon-si (KR)

(72) Inventors: In-young LEE, Hwaseong-si (KR); Chee-hwan YANG, Yongin-si (KR); Tae-young KIM, Suwon-si (KR); Sang-hoon CHOI, Suwon-si (KR)

(21) Appl. No.: 13/906,820

(22) Filed: May 31, 2013

(30) Foreign Application Priority Data
Dec. 24, 2012 (KR) 10-2012-0152406

(51) Int. Cl. H01Q 1/38

(52) U.S. Cl. CPC H01Q 1/38
USPC 343/700 MS; 29/600

(57) ABSTRACT

An antenna includes a sintered body block with a predetermined magnetic permeability or a predetermined dielectric constant, the sintered body block having at least one air cavity; and an antenna pattern formed on a surface of the sintered body block.

### CROSS-REFERENCE TO RELATED APPLICATIONS

This application claims the benefit under 35 U.S.C. §119(a) from Korean Patent Application No. 2012-0152406 filed Dec. 24, 2012 in the Korean Intellectual Property Office, the disclosure of which is incorporated herein by reference in its entirety.

### BACKGROUND OF THE INVENTION

1. Field of the Invention

The present disclosure relates to an antenna, an electronic apparatus with the same, and an antenna manufacturing method. More particularly, the present disclosure relates to an antenna that can extend frequency bandwidth by using a sintered body block with at least one air cavity, an electronic apparatus with the same, and an antenna manufacturing method.

2. Description of the Related Art

Recently, due to demands of miniaturization of an individual mobile communication terminal for increasing mobility thereof and of multi-functions of a multi-mode terminal that allows it to be used in a plurality of mobile communication systems according to the development of the information society, antennas that can be miniaturized and used in multiband are required.

In recent years, in order to implement miniaturized multiband antennas, various chip antenna structures miniaturized by a way to deform structurally a radiation patch or to design three-dimensionally a radiation structure, and by combining a resonant structure to minimize the reactance of the power supply direction and a simple deformation structure with slits like a planar inverted-F antenna (PIFA) structure have been introduced.

However, unlike planar antennas using a wide plane radiator pattern, compact chip antennas have difficulty in securing the bandwidth. In detail, as intervals between the radiator patterns are narrowed, mutual capacitance is increased. Resonant frequency can be adjusted by changing the mutual capacitance. However, there is a phenomenon that the bandwidth of the resonant frequency may generally be reduced as the mutual capacitance of the antenna is increased.

### SUMMARY OF THE INVENTION

The present inventive concept overcomes the above described drawbacks and other problems associated with the conventional arrangement. Exemplary embodiments of the present inventive concept provide an antenna that can extend frequency bandwidth by using a sintered body block with at least one air cavity, an electronic apparatus with the same, and an antenna manufacturing method.

Additional features and utilities of the present general inventive concept will be set forth in part in the description which follows and, in part, will be obvious from the description, or may be learned by practice of the general inventive concept.

Exemplary embodiments of the present inventive concept may be achieved by providing an antenna, which may include a sintered body block with a predetermined magnetic permeability or a predetermined dielectric constant, the sintered body block having at least one air cavity; and an antenna pattern formed on a surface of the sintered body block.

The air cavity may penetrate from one side of the sintered body block to another side thereof opposite to the one side.

The air cavity may be placed in a center of the one side.

The antenna pattern may be placed on one side of the sintered body block in which there is the air cavity.

The antenna may include a power supplying unit that is placed on another side adjacent to the one side, and supplies power to the antenna pattern.

The antenna pattern may be bent at least once.

The antenna pattern may be placed on one side of the sintered body block in which there is the air cavity and another side adjacent to the one side.

The antenna pattern may include a first antenna pattern placed on the one side of the sintered body in which there is the air cavity; and a second antenna pattern connected to the first antenna pattern and placed on another side adjacent to the one side.

The first antenna pattern may be bent at least once.

The sintered body block may include a plurality of air cavities.

The sintered body block may include a protrusion area projecting into the air cavity.

The sintered body block may be formed of a ceramic sintered body or a ferrite sintered body.

A width of one side of the sintered body block in which the air cavity is exposed may be greater than or equal to 1 mm.

A length of one side of the sintered body block in which the air cavity is exposed may be greater than or equal to 4.5 mm.

Exemplary embodiments of the present inventive concept may also be achieved by providing an antenna that may include a sintered body block having an air cavity; and an antenna pattern formed on one side of the sintered body block in which there is the air cavity and another side adjacent to the one side.

The antenna pattern may include a first antenna pattern bent once and placed on the one side of the sintered body in which there is the air cavity; and a second antenna pattern formed on the another side and connected to the first antenna pattern.

Exemplary embodiments of the present inventive concept may also be achieved by providing an electronic apparatus that may include an antenna; and a communication interface unit to perform communication with an external device via the antenna, wherein the antenna may include a sintered body block with a predetermined magnetic permeability or dielectric constant, the sintered body block having at least one air cavity; and an antenna pattern formed on a surface of the sintered body block.

The antenna pattern may be placed on one side of the sintered body block in which there is the air cavity; and the antenna may include a power supplying unit that is placed on another side adjacent to the one side and supplies power to the antenna pattern.

The communication interface unit may include a circuit board on which the antenna is placed, and the power supplying unit may be electrically connected to the circuit board.

The antenna pattern may include a first antenna pattern placed on the one side of the sintered body in which there is the air cavity; and a second antenna pattern connected to the first antenna pattern and placed on another side adjacent to the one side.

The communication interface unit may include a circuit board on which the antenna is placed, and the second antenna pattern is electrically connected to the circuit board.

Exemplary embodiments of the present inventive concept may also be achieved by providing an antenna manufacturing method that may include molding a sintered body block having at least one air cavity by using sintered powder with high dielectric constant or high magnetic permeability; forming an antenna pattern on a surface of the sintered body block; and baking the sintered body block on which the antenna pattern is formed.

Exemplary embodiments of the present inventive concept may also be achieved by providing an electronic apparatus, comprising: an antenna including: a sintered body block having an air cavity, and an antenna pattern formed on at least one side of the sintered body block in which there is the air cavity; and a communication interface unit to perform communication with an external device via the antenna.

In an exemplary embodiment, the antenna pattern is formed on the one side of the sintered block body in which there is the air cavity and another side adjacent to the one side.

In an exemplary embodiment, the antenna further includes a power supply unit formed on another side of the sintered block body adjacent to the one side on which the antenna is formed.

Other features and utilities of the present disclosure will become apparent from the following detailed description, which, taken in conjunction with the annexed drawings, discloses preferred embodiments.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating a configuration of an electronic apparatus according to an embodiment of the present disclosure;

FIG. 2 is a perspective view illustrating a configuration of an antenna according to an embodiment of the present disclosure;

FIGS. 3, 4, and 5 are views for explaining performance depending on a width of an antenna;

FIGS. 6A, 6B, and 7 are views for explaining performance of an antenna according to an exemplary embodiment of the present disclosure;

FIG. 8 is a view for explaining a structure of an antenna according to another embodiment of the present disclosure;

FIG. 9 is a view for explaining a structure of an antenna according to yet another embodiment of the present disclosure;

FIG. 10 is a view for explaining a structure of an antenna according to still another embodiment of the present disclosure;

FIG. 11 is a view for explaining a structure of an antenna according to yet another embodiment of the present disclosure;

FIG. 12 is a view for explaining a structure of an antenna according to still another embodiment of the present disclosure;

FIG. 13 is a view for explaining a structure of an antenna according to yet another embodiment of the present disclosure;

FIG. 14 is a view for explaining a structure of an antenna according to still another embodiment of the present disclosure; and

FIG. 15 is a flowchart for explaining an antenna manufacturing method according to an embodiment of the present disclosure.

Throughout the drawings, like reference numerals will be understood to refer to like parts, components and structures.

### DETAILED DESCRIPTION OF THE PREFERRED EMBODIMENTS

Hereinafter, certain exemplary embodiments of the present disclosure will be described in detail with reference to the accompanying drawings.

The matters defined herein, such as a detailed construction and elements thereof, are provided to assist in a comprehensive understanding of this description. Thus, it is apparent that exemplary embodiments may be carried out without those defined matters. Also, well-known functions or constructions are omitted to provide a clear and concise description of exemplary embodiments. Further, dimensions of various elements in the accompanying drawings may be arbitrarily increased or decreased for assisting in a comprehensive understanding.

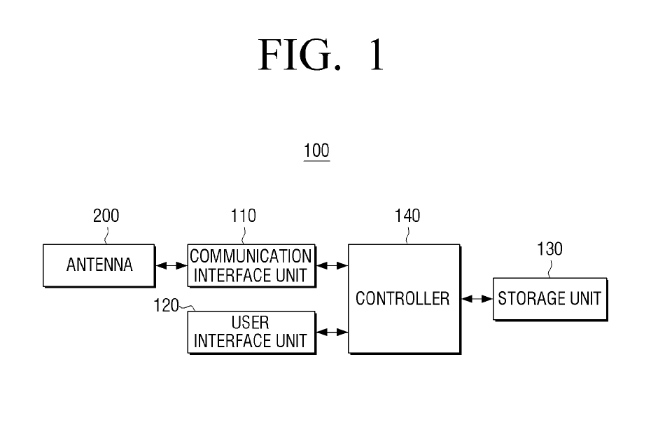

FIG. 1 is a block diagram illustrating a configuration of an electronic apparatus according to an embodiment of the present disclosure.

Referring to FIG. 1, an electronic apparatus 100 according to an embodiment of the present disclosure includes a communication interface unit 110, a user interface unit 120, a storage unit 130, a controller 140, and an antenna 200. Here, the electronic apparatus 100 refers to a device that can perform communication with external apparatuses by using an antenna such as personal computers (PCs), notebook computers, tablet computers, portable multimedia players (PMPs), smart phones, etc.

The communication interface unit 110 is configured to connect the electronic apparatus 100 to external apparatuses (not illustrated), and can be connected to the external apparatuses by a wireless communication method using the antenna 200 (for example, GSM, UMTS, LTE, WiBRO, WiFi, Bluetooth, etc.) as well as via a local area network (LAN) and the internet.

The communication interface unit 110 includes a circuit board in which the antenna 200 can be disposed. Here, the circuit board can be electrically connected to an antenna pattern or a power supply unit of the antenna 200, and supplies the antenna 200 with electromagnetic energy.

The user interface unit 120 includes a plurality of function keys to allow a user to set or select various functions supported by the electronic apparatus 100, and can display various types of information provided by the electronic apparatus 100. The user interface unit 120 may be implemented as an apparatus that can simultaneously implement input and output such as a touch screen, etc., or an apparatus formed by combination of a mouse and a monitor.

The storage unit 130 stores programs to drive of the electronic apparatus 100. In detail, the storage unit 130 may store programs that are a set of various commands required when the electronic apparatus 100 is driven. Here, the programs include a master boot record (MBR) (or GUID partition table (GPT)) and an operation system.

The storage unit 130 may be implemented as storage media within the electronic apparatus 100 (for example, flash memories, hard disk drives (HDDs), solid state drives (SSDs), etc.) and external storage media (for example, removable disks including an USB memory, storage media connected to a host, web servers through networks, etc).

The controller 140 performs control with respect to elements inside the electronic apparatus 100. In detail, the controller 140 may determine an operation mode of the electronic apparatus 100 by determining whether the user's operation is performed, a lapsed time of the user's operation, etc.

The controller 140 may control the elements inside the electronic apparatus 100 to have an operation state corresponding to the determined operation mode. In detail, the electronic apparatus 100 may have a normal mode, a plurality of power saving modes, and an off mode. Here, the normal mode refers to an operation mode in which the elements inside the electronic apparatus 100 are supplied with the power and perform a process requested by the user. The power saving mode refers to an operation mode in which the power to be supplied to specific elements is blocked or minimized in order to minimize the power consumption in the electronic apparatus 100. The off mode refers to a state in which the electronic apparatus 100 is not operated. For example, the controller 140 may block the power from being supplied to the antenna 200 in the power saving mode.

The controller 140 may perform a booting operation by using an operation system stored in the storage unit 130 when a booting command is entered. Then, after the booting operation is completed, the controller 140 may perform functions corresponding to user's commands input through the user interface unit 120.

Since the electronic apparatus 100 according to an embodiment of the present disclosure as described above may perform communication with external apparatuses by using an antenna that will be described later, the size of the electronic apparatus 100 may be reduced and an effective communication is possible.

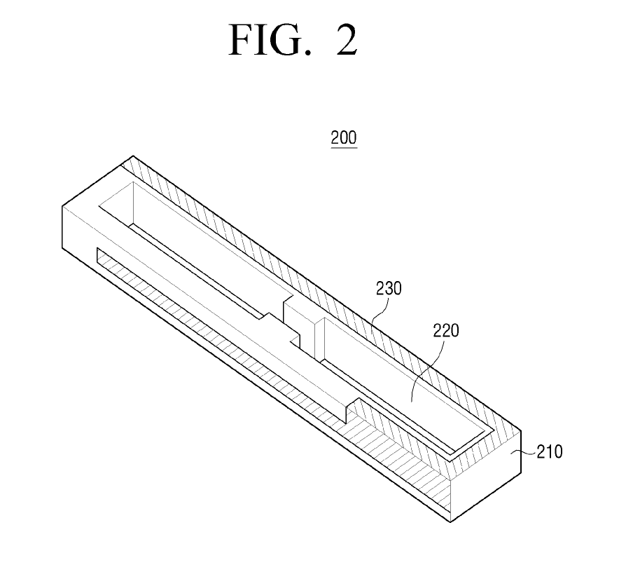

FIG. 2 is a perspective view illustrating a configuration of an antenna according to an embodiment of the present disclosure.

Referring to FIG. 2, the antenna 200 according to an embodiment of the present disclosure includes a sintered body block 210 and an antenna pattern 230. The antenna 200 is a chip antenna (or a bulk type antenna) which is implemented in a form of a chip.

The sintered body block 210 has predetermined magnetic permeability or a predetermined dielectric constant. In detail, the sintered body block 210 may be implemented as a ceramic sintered body or a ferrite sintered body. In the present embodiment, the sintered body block 210 is described to use the ceramic sintered body or ferrite sintered body; however, various sintered bodies may be used as the sintered body block as long as they have high magnetic permeability or a high dielectric constant. Alternatively, sintered bodies having both the high magnetic permeability and the high dielectric constant may be used as the sintered body block. Here, the predetermined dielectric constant means a case that the dielectric constant Er is greater than or equal to 10. The predetermined magnetic permeability means a case that the dielectric constant Er is greater than or equal to 10 and the magnetic permeability Mr is greater than or equal to 5.

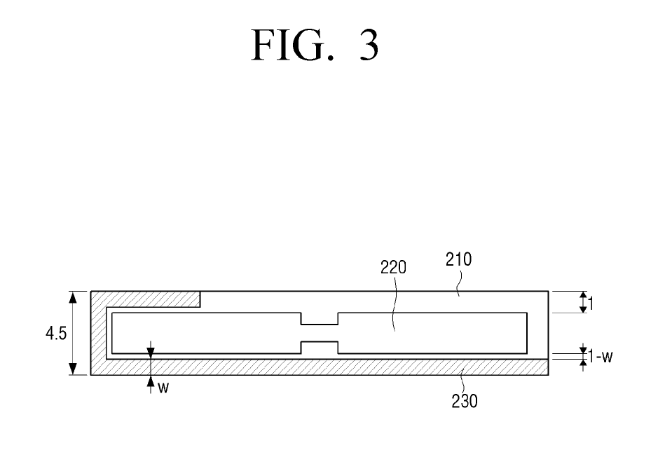

The sintered body block 210 may be formed in a hexahedron. In detail, the sintered body block 210 is formed in a rectangular parallelepiped having a dimension of 25 mm long, 4.5 mm wide, and 2.5 mm high. A length of one side of the sintered body block 210 in which the air cavity is exposed may be greater than or equal to 4.5 mm, and a width of the one side of the sintered body block 210 on which the air cavity is exposed may be greater than or equal to 1 mm. The reason for these dimensions will be described later with reference to FIGS. 3, 4, and 5. On the other hand, the dimensions are those of the sintered body block 210 when the ceramic sintered body or the ferrite sintered body is used as the sintered body block 210. Therefore, if different sintered bodies are used, the dimensions may be changed adaptively depending on the corresponding sintered body.

Hereinafter, in order to facilitate the description, the longest edges of the rectangular parallelepiped sintered body block are referred to as a length, the shortest edges thereof are referred to as a height, and the other edges other than the longest and shortest edges thereof are referred to as a width. On the other hand, in the present embodiment, the sintered body block 210 is formed in a rectangular parallelepiped shape; however, it may be implemented as different polyhedrons other than the rectangular parallelepiped.

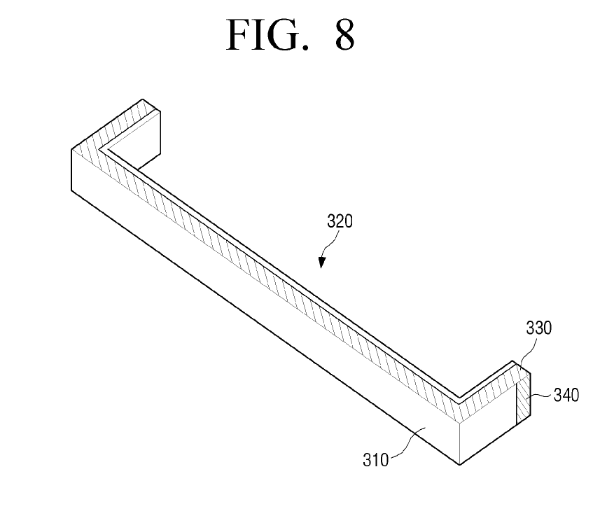

Here, the air cavity is an empty space formed between the antenna patterns formed on the sintered body block. The air cavity according to the present embodiment may be placed in a central area of the sintered body block as illustrated in FIG. 2 or in an edge area of the sintered body block as illustrated in FIG. 8. Specific functions and effects of the air cavity will be described later.

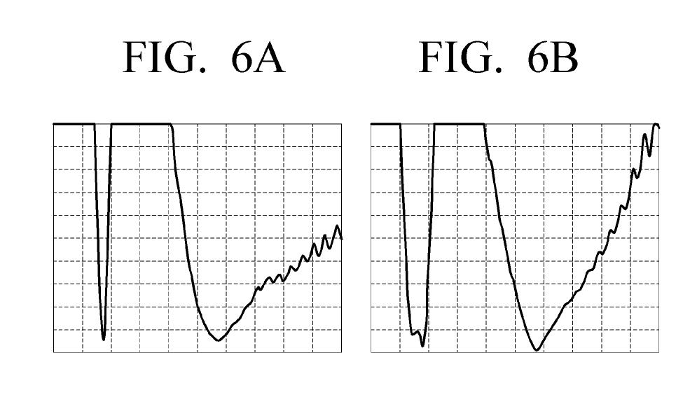

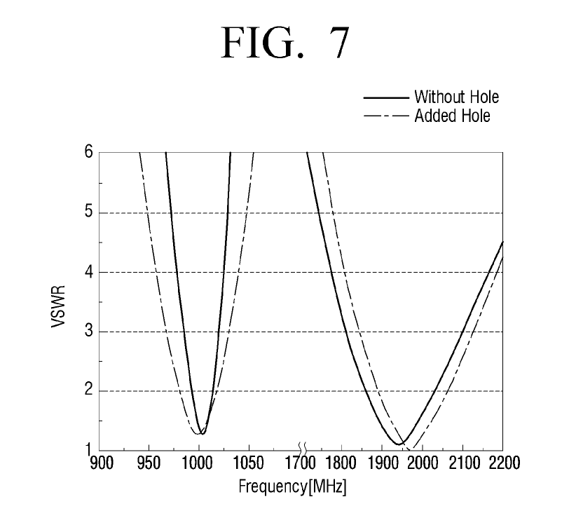

The sintered body block 210 as illustrated in FIG. 2 has the air cavity 220 (or an air gap). Here, the air cavity 220 is an empty space within the sintered body block, minimizes mutual interference generated between the antenna patterns formed on the surface of the sintered body block 210, and may be implemented in a form penetrating from one side of the sintered body block 210 to another side thereof opposite to the one side. The function of the air cavity 220 will be described later with reference to FIGS. 6 and 7. In the illustrated embodiment, the air cavity is 23 mm long, 2.5 mm wide, and 2.5 mm high, which is the same height as that of the sintered body block 210. The air cavity 220 is desirable to have a width of at least greater than or equal to 2.5 mm. The reason will be described later with reference to FIGS. 3, 4, and 5.

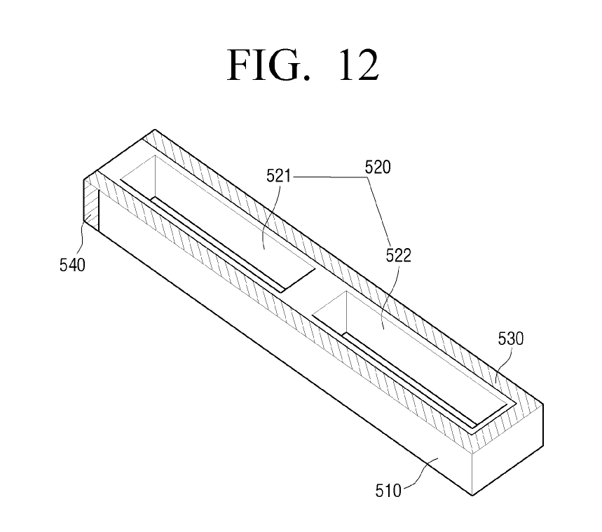

On the other hand, in the illustrated embodiment, the air cavity 220 is illustrated in the form penetrating the central area of one side of the sintered body block 210. However, the air cavity 220 may be formed in the edge area of the sintered body block as illustrated in FIG. 8. In the present embodiment, a single air cavity is illustrated to be formed in the sintered body block 210; however, a plurality of air cavities may be formed in the sintered body block as illustrated in FIGS. 12, 13, and 14. Also, in the illustrated embodiment, the air cavity is implemented in the form penetrating the sintered body block; however, the air cavity may be implemented in a recessed form not to penetrate the sintered body block.

The sintered body block 210 may include a protrusion area protruding into the air cavity 220. In detail, the dielectric constant or magnetic permeability of the sintered body block 210 may be adjusted by adjusting the protrusion size of the protrusion area of the sintered body block 210.

The antenna pattern 230 is formed on the surface of the sintered body block 210. In detail, the antenna pattern 230 performs a role to radiate electromagnetic waves. Here, the length of the antenna pattern 230 may be λ/4 of the band frequency. Here, λ is a wavelength. The width of the antenna pattern 230 may be at least greater than or equal to 0.6 mm.

The antenna pattern 230 may be arranged in a variety of forms on the surface of the sintered body block 210. In detail, the antenna pattern 230 may be formed on one side of the sintered body block 210 in which there is the air cavity 220 or may be placed on the one side of the sintered body block 210 in which there is the air cavity 220 and another side adjacent to the one side. For example, when the antenna pattern 230 is formed on two sides of the sintered body block 210 as illustrated in FIG. 2, the antenna pattern 230 may consist of a first antenna pattern placed on one side of the sintered body block in which there is the air cavity 220 and a second antenna pattern that is connected to the first antenna pattern and placed on another side adjacent to the one side. In the illustrated embodiment, the antenna pattern 230 is formed on two sides. However, as illustrated in FIGS. 8 to 14, the antenna pattern 230 may be formed on three or more sides as well as one side.

As described above, in the antenna 200 according to an embodiment of the present disclosure, since the air cavity exists between the antenna pattern 230, the mutual interference generated between the antenna pattern 230 may be minimized so that a phenomenon in which the bandwidth is narrowed due to the mutual interference may be minimized. In other words, since overall current distribution is evenly provided by forming the air cavity in the sintered body block 210, a problem in which the bandwidth is narrowed in the low frequency band (700˜1000 Mhz) may be solved.

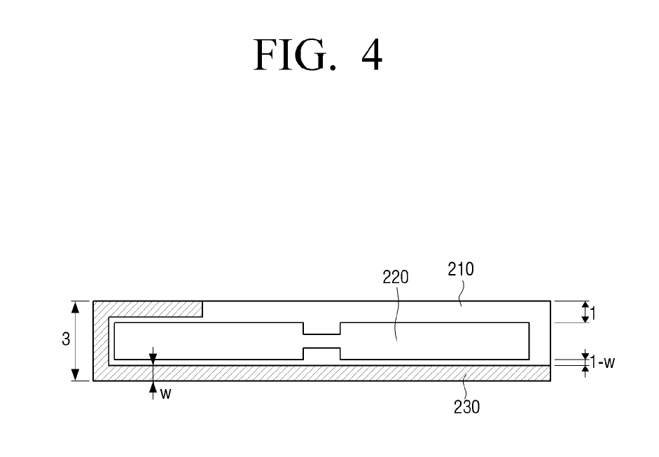

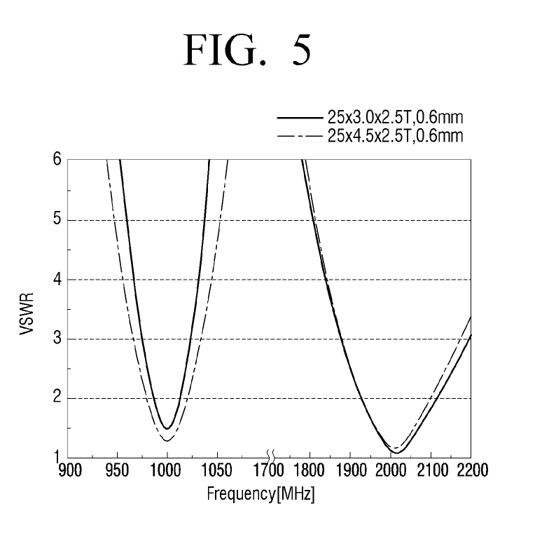

FIGS. 3, 4, and 5 are views for explaining performance depending on a width of an antenna. In detail, FIG. 3 is a view for explaining a size of the antenna when the antenna has a width (or vertical length) of 4.5 mm. FIG. 4 is a view for explaining a size of the antenna when the antenna has the width of 3 mm. FIG. 5 is a view illustrating VSWR when the widths of the antennas are 4.5 mm and 3 mm, respectively.

In order to form the antenna pattern on the sintered body block, the edge area of one side in which there is the air cavity may have a width of greater than or equal to 1 mm.

Accordingly, as illustrated in FIG. 3, when the antenna has the width of 4.5 mm, the air cavity may be formed to have a size of 23 mm×2.5 mm×2.5 mm. However, when the width of the antenna is 3 mm as illustrated in FIG. 4, the air cavity may be formed to have the width of only approximate 1 mm. In this case, as illustrated in FIG. 5, due to the narrow width of the air cavity, the bandwidth expansion of the antenna can not be effectively increased. Accordingly, it is desirable that the antenna is formed to have the width of at least greater than or equal to 4.5 mm.

FIGS. 6A, 6B, and 7 are views for explaining performance of an antenna according to an embodiment of the present disclosure.

The more the dielectric constant and magnetic permeability of a material configuring the sintered body block 210 are increased, the more the wavelength is shorten as shown in Formula 1. In other words, when the same wavelength is implemented, the size of the sintered body block may be reduced by using a material with high dielectric constant and magnetic permeability.

$$λ = \frac{V}{f} = \frac{{c}_{0}}{f \sqrt{{μ}_{r} {ɛ}_{r}}} = \frac{{λ}_{0}}{\sqrt{{μ}_{r} {ɛ}_{r}}} \qquad 〈 Formula 1 〉$$

Here, λ is a wavelength, V is a propagation speed, f is a frequency, Co is a capacitance, μᵣ is a relative permeability, εᵣ is a relative dielectric constant, and λ₀ is a wavelength in free space.

However, the higher the dielectric constant of the material configuring the sintered body block 210, the more the bandwidth is reduced. Accordingly, the width of the antenna pattern needs to be increased; however, in this case, the size of the antenna also is increased. In the present embodiment, since the air cavity is formed in the sintered body block instead of increasing the width of the antenna pattern, the antenna may have a similar high dielectric constant and high magnetic permeability, may be beneficial to broadband by increasing the bandwidth as shown in Formula 2, and may improve radiation efficiency of the antenna.

$$BW = \sqrt{\frac{{μ}_{r}}{{ɛ}_{r}}} \frac{96 ( t / {λ}_{o} )}{\sqrt{2} ( 4 + 17 \sqrt{{μ}_{r} {ɛ}_{r}} )} \qquad 〈 Formula 2 〉$$

Here, BW is a bandwidth, μᵣ is a relative permeability, εᵣ is a relative dielectric constant, and λ₀ is a wavelength in a free space.

Table 1 below is a table illustrating the difference in the bandwidth depending on the characteristics of the material.

TABLE 1

| Material | | | | |
|---|---|---|---|---|
| Characteristics | Er = 10 | Er = 20 | Er = 13, Mr = 8 | MR = 6.5, Mr = 4 |
| Ant.BW | 31 Mhz | 15.8 Mhz | 25 Mhz | 48.9 Mhz |
| (900 MHz) | | | | |

Table 2 below is a table illustrating the degree of change in capacitance depending on the shape of the air cavity within the sintered body block.

TABLE 2

| | | | Air cavity with | Air cavity with |
|---|---|---|---|---|
| | Existing bulk type | Air cavity | single bridge | double bridge |
| Structure | [symbol] | [symbol] | [symbol] | [symbol] |
| Material Characteristics | Er = 15, | Er = 11.5, | Er = 10.0, | Er = 9.0, |
| (magnetic) | Mr = 10 | Mr = 7 | Mr = 6.5 | Mr = 5.6 |
| Material Characteristics | Er = 15 | Er = 11.5 | Er = 10.0 | Er = 9.0 |
| (dielectric) | | | | |

Referring to Table 2 as described above, it can be seen that the dielectric constant and magnetic permeability of the sintered body block may be adjusted by adjusting the shape and the number of the air cavity within the sintered body block.

Hereinafter, performance of an antenna according to an embodiment of the present disclosure will be described with reference to FIGS. 6A, 6B and 7. FIG. 6A is a view illustrating standing wave ratio characteristics of an antenna with no air cavity, and FIG. 6B is a view illustrating standing wave ratio characteristics of an antenna with an air cavity and the same size as that of the antenna of FIG. 6A. FIG. 7 is a view illustrating both the standing wave ratio of FIG. 6A and the standing wave ratio of FIG. 6B on one drawing. In the illustrated views, the vertical axis indicates a voltage standing wave ratio (VSWR), and the horizontal axis indicates a frequency of 600˜3000 Mhz. Two sintered bodies of the antennas used in these experiments have a size of 22 mm×4.5 mm×2.5 mm.

Referring to FIGS. 6A, 6B and 7, it can be found that based on the standing wave ratio of 3 in the frequency range of the low-frequency band, the bandwidth of the existing antenna without the air cavity is 35 MHz, and the bandwidth of the antenna with the air cavity is 85 MHz so that the bandwidth is improved approximately 140%. This indicates that an antenna with an extended bandwidth in the low-frequency band may be implemented by forming the air cavity between the antenna pattern so as to make the overall current distribution evenly as described above. Table 3 below is to tabulate the values of FIG. 7.

TABLE 3

| | Initial Antenna | | Air Cavity Antenna | |
|---|---|---|---|---|
| Frequency | Low | High | Low | High |
| Band | | | | |
| Bandwidth | 35 Mhz | 290 Mhz | 85 Mhz | 215 Mhz |
| | ref | ref | 142.8% | 25.9% |
| | | | Increased | Decreased |

In the above descriptions with respect to FIGS. 2 to 7, the antenna pattern is illustrated and described to be formed on two sides; however, the antenna pattern may be formed on only one side of the sintered body block. This will be described hereinafter with reference to FIGS. 8 to 11. On the other hand, in the above descriptions, the sintered body block is illustrated and described to have a single air cavity; however, the sintered body block may be implemented to have a plurality of air cavities. This will be described hereinafter with reference to FIGS. 12, 13, and 14.

FIG. 8 is a view for explaining a structure of an antenna according to another embodiment of the present disclosure. In detail, FIG. 8 is a view illustrating an embodiment in which the air cavity is formed on an edge of the sintered body block.

Referring to FIG. 8, the antenna according to the present embodiment consists of a sintered body block 310, an antenna pattern 330, and a power supplying unit 340.

The sintered body block 310 is a rectangular parallelepiped shape if it does not have the air cavity. If the air cavity 320 is formed in a shape penetrating the edge of the sintered body block, the sintered body block is formed in a substantially flattened U shape as illustrated in FIG. 8. In this case, the thickness of one side of the sintered body block on which there is the air cavity may be greater than or equal to 1 mm.

The antenna pattern 330 is formed on the one side on which there is the air cavity 320, may have a width of at least greater than or equal to 0.6 mm, and may be formed to have two bends.

The power supplying unit 340 is placed on another side adjacent to the one side on which the antenna pattern 330 is formed, and supplies power to the antenna pattern 330. The power supplying unit 340 may be formed of the same material as that of the antenna pattern 330.

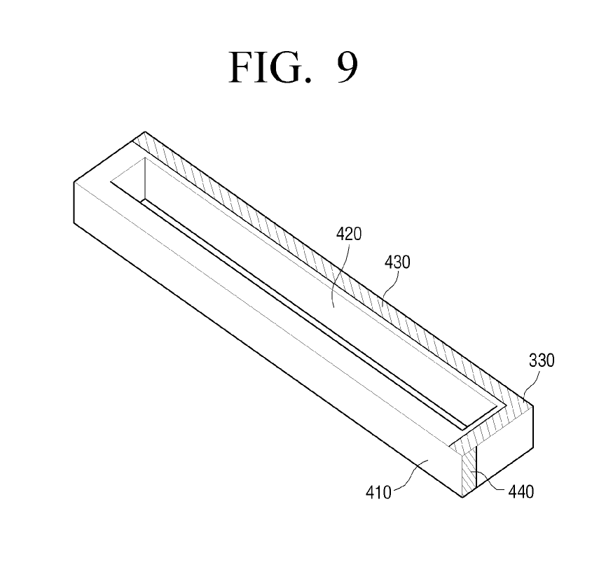

FIG. 9 is a view for explaining a structure of an antenna according to yet another embodiment of the present disclosure. In detail, FIG. 9 is a view for explaining an embodiment in which the air cavity is formed to penetrate the central portion of the sintered body block.

Referring to FIG. 9, the antenna according to the present embodiment consists of a sintered body block 410, an antenna pattern 430, and a power supplying unit 440. Since the sintered body block 410 according to the third embodiment has the same shape as that of the sintered body block 210 as illustrated in FIG. 2, description of the sintered body block 410 will be omitted.

The antenna pattern 430 is formed on one side of the sintered body block 410 on which there is the air cavity 420, and may be formed to have one bend around the air cavity 420.

The power supplying unit 440 is placed on another side adjacent to the one side on which the antenna pattern 430 is formed, and supplies power to the antenna pattern 430. The power supplying unit 440 may be formed of the same material as that of the antenna pattern 430.

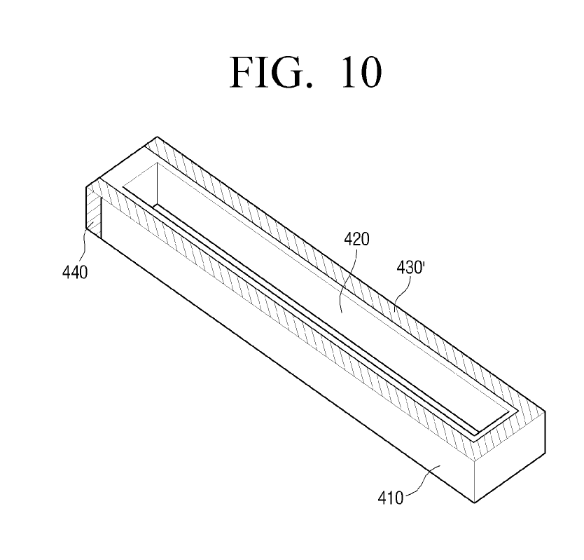

FIG. 10 is a view for explaining a structure of an antenna according to still another embodiment of the present disclosure. In detail, FIG. 10 is a view for explaining an embodiment in which the air cavity is formed to penetrate the central portion of the sintered body block.

Referring to FIG. 10, the antenna according to the present embodiment consists of a sintered body block 410, an antenna pattern 430′, and a power supplying unit 440. Since the sintered body block 410 according to the fourth embodiment has the same shape as that of the sintered body block 210 as illustrated in FIG. 2, description of the sintered body block 410 will be omitted.

The antenna pattern 430′ is formed on one side of the sintered body block 410 on which there is the air cavity 420, and may be formed in a substantially flatted U shape being bent twice around the air cavity 420.

The power supplying unit 440 is placed on another side adjacent to the one side on which the antenna pattern 430′ is formed, and supplies power to the antenna pattern 430′. The power supplying unit 440 may be formed of the same material as that of the antenna pattern 430′.

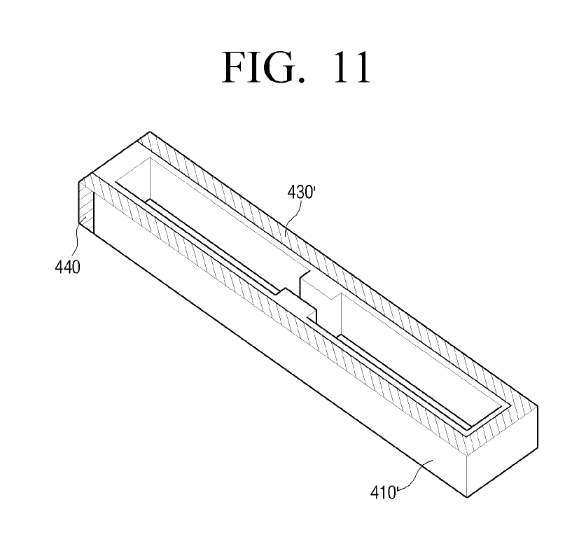

FIG. 11 is a view for explaining a structure of an antenna according to yet another embodiment of the present disclosure. In detail, FIG. 11 is a view for explaining an embodiment in which the sintered body block has a protrusion area.

Referring to FIG. 11, the antenna according to the present embodiment consists of a sintered body block 410′, an antenna pattern 430′, and a power supplying unit 440. Since the antenna according to the fifth embodiment is the same as the antenna according to the fourth embodiment except for the shape of the sintered body block 410′, descriptions of the antenna pattern 430′ and the power supplying unit 440 will be omitted.

The sintered body block 410′ includes at least one protrusion area. Here, the protrusion area is an area in which the sintered body block 410′ projects into the air cavity 420. The dielectric constant and/or the magnetic permeability of the sintered body block 410′ may be adjusted by adjusting the length or width of the protrusion area.

FIG. 12 is a view for explaining a structure of an antenna according to still another embodiment of the present disclosure. In detail, FIG. 12 is a view for explaining an embodiment in which a plurality of air cavities is provided in the sintered body block.

Referring to FIG. 12, the antenna according to the present embodiment includes a sintered body block 510, an antenna pattern 530, and a power supplying unit 540.

The sintered body block 510 includes a plurality of air cavities 521 and 522. A first air cavity 521 and a second air cavity 522 are formed to penetrate from one side of the sintered body block 510 to another side thereof opposite to the one side.

The antenna pattern 530 is formed on the one side of the sintered body block 510 on which there is the air cavity 520, and may be formed in a substantially flatted U shape being bent twice around the air cavity 520.

The power supplying unit 540 is placed on another side adjacent to the one side on which the antenna pattern 530 is formed, and supplies power to the antenna pattern 530. The power supplying unit 540 may be formed of the same material as that of the antenna pattern 530.

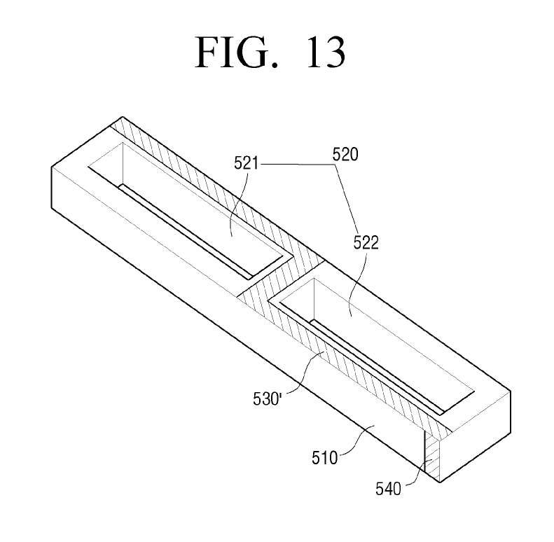

FIG. 13 is a view for explaining a structure of an antenna according to yet another embodiment of the present disclosure. In detail, FIG. 13 is a view for explaining an embodiment in which a plurality of air cavities is provided in the sintered body block.

Since the sintered body block 510 and air cavity 520 of the antenna according to the present embodiment of FIG. 13 have the same shape as those of FIG. 12, descriptions of the sintered body block 510 and air cavity 520 will be omitted.

The antenna pattern 530′ is formed on the one side of the sintered body block 510 on which there is the air cavity 520, and may be formed in a substantially zigzag shape being bent twice around the air cavity 520.

The power supplying unit 540 is placed on another side adjacent to the one side on which the antenna pattern 530′ is formed, and supplies power to the antenna pattern 530′. The power supplying unit 540 may be formed of the same material as that of the antenna pattern 530′.

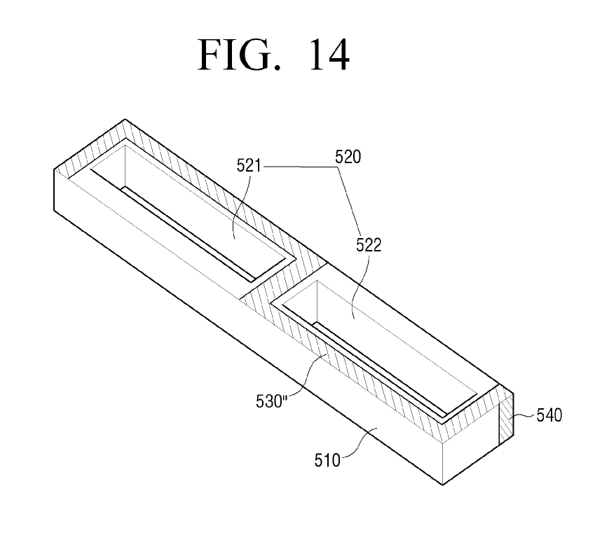

FIG. 14 is a view for explaining a structure of an antenna according to still another embodiment of the present disclosure. In detail, FIG. 14 is a view for explaining an embodiment in which a plurality of air cavities is provided in the sintered body block.

Since the sintered body block 510 and air cavity 520 of the antenna according to the present embodiment of FIG. 14 have the same shape as those of FIG. 12, descriptions of the sintered body block 510 and air cavity 520 will be omitted.

The antenna pattern 530″ is formed on the one side of the sintered body block 510 on which there is the air cavity 520, and may be formed in a substantially zigzag shape being bent four times around the air cavity 520 (including first cavity 521 and second cavity 522). In other words, the antenna pattern 530″ is formed to be bent around the first air cavity 521 twice and bent around the second air cavity 522 twice, thus forming four bends in total.

The power supplying unit 540 is placed on another side adjacent to the one side on which the antenna pattern 530″ is formed, and supplies power to the antenna pattern 530″. The power supplying unit 540 may be formed of the same material as that of the antenna pattern 530″.

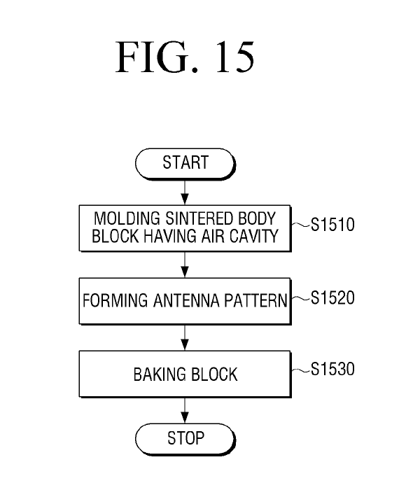

FIG. 15 is a flowchart for explaining an antenna manufacturing method according to an embodiment of the present disclosure.

Referring to FIG. 15, a sintered body block with at least one air cavity is formed by using sintered powder (operation S1510). In detail, in order to form a shape of the sintered body block as illustrated in FIGS. 2, 8, 9, and 12, raw material powder, such as ceramic or ferrite powder, is formed into a block through a pressing process using a predetermined mold, and then, a sintering process using a temperature above a predetermined temperature and a lapping process are performed with respect to the formed block, thereby forming the sintered body block having a predetermined dielectric constant or a predetermined magnetic permeability.

Then, an antenna pattern is formed on the sintered body block (operation S1520). In detail, a conductive material such as silver paste, etc., may be deposited (or printed) on the sintered body block in order to form one of antenna patterns as illustrated in FIGS. 2, 8, 9, 10, 11, 12, 13, and 14 or different antenna patterns other than those illustrated.

Then, the sintered body block on which the antenna pattern is formed is baked (operation S1530). In detail, the sintered body block on which a predetermined antenna pattern is formed is heated so that an antenna as illustrated in FIGS. 2, 8, 9, 10, 11, 12, 13, and 14 may be formed.

With an antenna manufacturing method according to an embodiment of the present disclosure, since an antenna may be manufactured by changing a mold used to make a sintered body block in a conventional antenna manufacturing process, an antenna with enhanced performance can be formed easily. Also, since an antenna is formed by using a method in which an antenna pattern is printed on a sintered body block, process simplification and cost reduction are possible.

While the embodiments of the present disclosure have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the inventive concepts.

What is claimed is:

1. An antenna comprising:
a sintered body block with a predetermined magnetic permeability or a predetermined dielectric constant, the sintered body block having at least one air cavity; and
an antenna pattern formed on a surface of the sintered body block.

2. The antenna of claim 1, wherein
the air cavity penetrates from one side of the sintered body block to another side thereof opposite to the one side.

3. The antenna of claim 2, wherein
the air cavity is placed in a center of the one side.

4. The antenna of claim 1, wherein
the antenna pattern is placed on one side of the sintered body block in which there is the air cavity.

5. The antenna of claim 4, further comprising:
a power supplying unit that is placed on another side adjacent to the one side, and supplies power to the antenna pattern.

6. The antenna of claim 4, wherein
the antenna pattern is bent at least once.

7. The antenna of claim 1, wherein
the antenna pattern is placed on one side of the sintered body block in which there is the air cavity and another side adjacent to the one side.

8. The antenna of claim 7, wherein
the antenna pattern comprises:
a first antenna pattern placed on the one side of the sintered body in which there is the air cavity; and
a second antenna pattern connected to the first antenna pattern and placed on another side adjacent to the one side.

9. The antenna of claim 8, wherein
the first antenna pattern is bent at least once.

10. The antenna of claim 1, wherein
the sintered body block comprises a plurality of air cavities.

11. The antenna of claim 1, wherein
the sintered body block comprises a protrusion area projecting into the air cavity.

12. The antenna of claim 1, wherein
the sintered body block is formed of a ceramic sintered body or a ferrite sintered body.

13. The antenna of claim 1, wherein
a width of one side of the sintered body block in which the air cavity is exposed is greater than or equal to 1 mm.

14. The antenna of claim 1, wherein
a length of one side of the sintered body block in which the air cavity is exposed is greater than or equal to 4.5 mm.

15. An antenna comprising:
a sintered body block having an air cavity; and
an antenna pattern formed on one side of the sintered body block in which there is the air cavity and another side adjacent to the one side.

16. The antenna of claim 15, wherein
the antenna pattern comprises
a first antenna pattern bent once and placed on the one side of the sintered body in which there is the air cavity; and
a second antenna pattern formed on the another side and connected to the first antenna pattern.

17. An electronic apparatus comprising:
an antenna; and
a communication interface unit to perform communication with an external device via the antenna,
wherein the antenna comprises
a sintered body block with a predetermined magnetic permeability or dielectric constant, the sintered body block having at least one air cavity; and
an antenna pattern formed on a surface of the sintered body block.

18. The electronic apparatus of claim 17, wherein
the antenna pattern is placed on one side of the sintered body block in which there is the air cavity; and
the antenna further comprises a power supplying unit that is placed on another side adjacent to the one side and supplies power to the antenna pattern.

19. The electronic apparatus of claim 18, wherein
the communication interface unit comprises a circuit board on which the antenna is placed, and
the power supplying unit is electrically connected to the circuit board.

20. The electronic apparatus of claim 17, wherein
the antenna pattern comprises
a first antenna pattern placed on the one side of the sintered body in which there is the air cavity; and
a second antenna pattern connected to the first antenna pattern and placed on another side adjacent to the one side.

21. The electronic apparatus of claim 20, wherein
the communication interface unit comprises a circuit board on which the antenna is placed, and
the second antenna pattern is electrically connected to the circuit board.

22. An antenna manufacturing method comprising:
molding a sintered body block having at least one air cavity by using sintered powder with high dielectric constant or high magnetic permeability;
forming an antenna pattern on a surface of the sintered body block; and
baking the sintered body block on which the antenna pattern is formed.

23. An electronic apparatus, comprising:
an antenna including:
a sintered body block having an air cavity, and
an antenna pattern formed on at least one side of the sintered body block in which there is the air cavity; and
a communication interface unit to perform communication with an external device via the antenna.

24. The electronic apparatus of claim 23, wherein the antenna pattern is formed on the one side of the sintered block body in which there is the air cavity and another side adjacent to the one side.

25. The electronic apparatus of claim 23, wherein the antenna further includes a power supply unit formed on another side of the sintered block body adjacent to the one side on which the antenna is formed.
